(19) United States
(12) Patent Application Publication
(10) Pub. No.: US 2025/0343316 A1
(43) Pub. Date: Nov. 6, 2025

(54) INTER-BATTERY SPACER AND THERMAL REGULATION SYSTEM FOR A SET OF BATTERIES

(71) Applicant: VALEO SYSTEMES THERMIQUES, La Verriere (FR)

(72) Inventors: Julien TISSOT, La Verriere (FR); Kamel AZZOUZ, La Verriere (FR); Moussa NACER-BEY, La Verriere (FR); Julio GUERRA, La Verriere (FR)

(73) Assignee: VALEO SYSTEMES THERMIQUES, La Verriere (FR)

(21) Appl. No.: 18/866,762

(22) PCT Filed: May 9, 2023
(86) PCT No.: PCT/EP2023/062282

§ 371 Date: Nov. 18, 2024

(30) Foreign Application Priority Data
May 16, 2022 (FR) 2204641

(51) Int. Cl. H01M 50/291; B60L 50/64; B60L 58/26; H01M 10/625; H01M 10/647; H01M 10/6568; H01M 50/209; H01M 50/249

(52) U.S. Cl. CPC H01M 50/291; B60L 50/64; H01M 10/625; H01M 10/647; H01M 10/6568; H01M 50/209; H01M 50/249; B60L 58/26; H01M 2220/20

(57) ABSTRACT

The invention relates to an inter-battery spacer intended to space apart two contiguous battery cells in a housing for battery cells of a vehicle, the spacer consisting of a one-piece element positioned in contact around the first battery cell, the spacer including a base on which the lower face of the first battery cell at least partially rests, and a plurality of longitudinal segments extending from the base in the direction of the upper face of the first battery cell, at least one of the longitudinal segments extending along the large lateral face contiguous with the second battery cell such that the segment is configured to come into contact with the contiguous second battery cell.

### TECHNICAL FIELD

The subject of the present invention is an inter-battery spacer and a thermal regulation system for a set of batteries.

The invention relates to the technical field of electrical energy storage elements, in particular batteries, used for vehicles, and more particularly the devices, systems and methods used to manage the negative consequences of heating of said electrical energy storage elements.

Hereinafter, for the sake of simplicity, the term “battery” is used to denote a battery cell.

### BACKGROUND OF THE INVENTION

Thus, the invention is also advantageously applicable in the field of devices for thermal regulation of an electrical energy storage device, such as a set of batteries or battery pack for an electric and/or hybrid motor vehicle.

The electrical energy for electric and/or hybrid vehicles is provided by one or more batteries. During their operation, electrical energy storage elements, such as batteries, are caused to heat up and thus run the risk of being damaged. In particular, one charging technique, referred to as rapid charging, consists in charging the energy storage elements at a high voltage and high amperage for a short time, in particular for a maximum time of about twenty minutes. This rapid charging entails significant heating of the electrical energy storage elements, which must be handled.

A certain number of documents are known from the prior art.

Document FR 3060863 describes an inter-battery spacer intended to be placed between two contiguous batteries, the spacer extending over the entire surface of the large contiguous faces of the two batteries.

Also known is document WO 21072726 which describes an inter-battery spacer formed of a solid frame of L-shaped section having protruding grooves so as to house each of the batteries between said grooves.

Also known are documents US2013004822 and US2021057794 which describe inter-battery spacers formed of a panel or of a wall disposed between the two contiguous batteries, thus making it possible to contain the mechanical loads (swelling) during the heating of the batteries but preventing any flow of fluid intended to cool the batteries.

Conversely, it is known from document CN 105261720 an inter-battery spacer being inserted between the two contiguous batteries, at their upper parts, facilitating the flow of a dielectric fluid between the batteries but offering no protection for countering the swelling of a battery.

The solutions of the prior art are not entirely satisfactory in that they do not effectively resolve the multitude of functions dedicated to such an inter-battery spacer. Specifically, each solution of the prior art resolves one of the functions of an inter-battery spacer to the detriment, to a greater or lesser extent, of one or more other objectives of such an element.

The invention aims to remedy this state of affairs.

In particular, an objective of the invention is to simplify the design of the inter-battery spacers so as to reduce costs.

Another objective of the invention is to maintain the distance between the batteries, or a minimum distance between the batteries, including during swelling of one or both batteries.

An additional objective of the invention is to ensure a sufficient compression rate so as to constrain the battery and prevent its swelling.

Another objective of the invention is to improve the heat exchanges between the dielectric fluid and the battery, in other words to optimize the flow of this dielectric fluid all the way around the battery.

Still, an objective of the present invention consists in permitting maximum cooling of the busbars of the batteries.

Yet another objective of the invention is to propose an inter-battery spacer that is reliable with regard to its technical objectives while still being as economical as possible, both in terms of its composition, its manufacture and its service life.

### SUMMARY OF THE INVENTION

It has thus been found by the applicant, after various experiments and trials, that it is particularly advantageous to realize an inter-battery spacer having a simple and refined form capable of ensuring the support and spacing functions for each battery.

To this end, the inter-battery spacer according to the invention simply has a base for the function of supporting the battery and a plurality of longitudinal segments extending from this base both for the function of spacing between the contiguous batteries and for the function of mechanical strength intended to limit any swelling of the battery.

While realizing these two essential functions, the form of this inter-battery spacer also enables optimal cooling of the battery, by virtue of the dielectric fluid, due to a minimal battery-covering surface.

Thus, the solution proposed by the invention relates to an inter-battery spacer intended to space apart two contiguous battery cells in a housing for battery cells of a vehicle,
the, for example substantially identical, first and second battery cells each being in the form of a rectangular parallelepiped having two large lateral faces, two small lateral faces, a lower face and an upper face,
the first and the second battery cells being configured to be aligned and contiguous respectively at one of their large lateral faces.

The inter-battery spacer is noteworthy in that it consists of a one-piece element positioned in contact around the first battery cell, said spacer comprising:
a base on which said lower face of the first battery cell at least partially rests, and
a plurality of longitudinal segments extending from said base in the direction of said upper face of said first battery cell, at least one of said longitudinal segments extending along the large lateral face contiguous with the second battery cell such that said segment is configured to come into contact with the contiguous second battery cell.

By virtue of the structure of the inter-battery spacer according to the invention, which is both simple to design/manufacture and mechanically resistant, all of the aforementioned objectives for an inter-battery spacer are met.

A particularly interesting aspect of the invention resides in the fact that the battery is held along all axes, studs or lugs potentially being used to axially immobilize the battery on the base of the spacer by using the base and/or the longitudinal segments to position these studs or these lugs.

A particularly interesting aspect of the invention resides in the vertical extension (along the axis z in FIGS. 1 to 3) of the longitudinal segments, this corresponding to a direction tangential to the flow of a dielectric fluid dispersed at the upper level of the batteries, on the upper faces, notably on the busbars, and/or on the small lateral faces.

The expression “substantially identical” in relation to the (first and second) batteries is understood to mean that the two batteries can have different dimensions in terms of height and/or length but the smaller of the two contiguous batteries has a large lateral face at least equal to 50% in terms of surface area of the large lateral face of the larger battery.

The expression “aligned and contiguous” in relation to the (first and second) batteries is understood to mean that their contiguous large lateral faces face one another. According to one possibility, this expression includes the case of an offset between these two contiguous large lateral faces, but at least 50% of the surface of each of the two large lateral faces of each contiguous battery must be facing one another.

Further advantageous features of the apparatus that forms the subject matter of the invention are listed hereinbelow. Each of these features may be considered alone or in combination with the notable features defined hereinabove. Each of these features contributes, as appropriate, to solving specific technical problems defined earlier on in the description, to which problems the notable features defined hereinabove do not necessarily contribute. The latter may form the subject matter, as appropriate, of one or more divisional patent applications:

According to a particularly interesting aspect of the invention, said base has an underframe intended to raise the battery cell with respect to the bottom of the housing.

Also according to another very interesting aspect of the invention, the base of the inter-battery spacer is perforated.

The term “perforated” is understood to mean that the base has a plurality of cutouts between the crosspieces or similar forming the structure of the base. In this way, with the underframe, the dielectric fluid can contactingly surround each battery, including below the battery, such that the effectiveness of the thermal cooling thereof is improved significantly.

According to an advantageous embodiment, the underframe of the base consists of a plurality of vertical studs having a height of between 1 mm and 6 mm, preferably of between 3 mm and 5 mm.

Preferably, the longitudinal segments comprise at least one longitudinal segment referred to as end longitudinal segment, advantageously two, situated in close proximity to one of the aforementioned small lateral faces, advantageously respectively to the two small lateral faces.

The expression “close proximity” in connection with the segment referred to as end segment is understood to mean that this or these segments are situated, against the large lateral face, at the corner or the edge of this face with the small lateral face or at a maximum distance of 5 mm (millimeters), advantageously a maximum distance of 2 mm, from this corner/edge.

Advantageously, the or said end longitudinal segment(s) comprises (comprise) at least one transversely extending lateral stud.

The term “transversely” in connection with the lateral stud is understood to mean that this or these studs extend along the axis x in FIGS. 1 to 3, that is to say an angle perpendicular to the vertical (along z) and to the length (along y).

Preferably, the inter-battery spacer comprises a plurality of such transverse studs, as many as are required to transversely wedge or immobilize the battery on the inter-battery spacer.

According to one embodiment, the lateral stud has a length of between 1 mm and 6 mm, preferably of between 3 mm and 5 mm.

According to an advantageous embodiment of the invention, all the longitudinal segments extend along that large lateral face of the first battery cell which is contiguous with the second battery cell.

Advantageously, at least two longitudinal segments, preferably at least half of the longitudinal segments, extend in a central portion of that large lateral face of the first battery cell which is contiguous with the second battery cell, said central portion representing at most 50% of said large face.

According to a particularly interesting aspect of the invention, the longitudinal segments occupy at most 10%, advantageously at most 5%, of the surface of that large lateral face of the first battery cell which is contiguous with the second battery cell.

Preferably, at least one of said longitudinal segments, advantageously all the longitudinal segments, extends (extend) in length over the entirety of the lateral face of the first battery cell.

Advantageously, said base has a length at most equal to that of the lower face of the first battery cell.

Advantageously, said longitudinal segments have a thickness of between 0.5 mm and 5 mm, preferably of between 1 mm and 4 mm.

The term “thickness” in connection with the longitudinal segments is understood to mean that this thickness is considered to be a distance along the axis y (cf. FIGS. 1 to 3).

Advantageously, said longitudinal segments have a width of between 0.5 mm and 5 mm, preferably of between 1 mm and 4 mm.

The term “thickness” in connection with the longitudinal segments is understood to mean that this thickness is considered to be a distance along the axis x (cf. FIGS. 1 to 3).

According to one embodiment of the invention, said underframe is fastened, preferably by bonding, to the bottom of the housing.

The term “bonding” is understood to mean the inter-battery spacer can in itself adhere by fastening to the bottom of the housing, for example if the latter consists of a vinyl polymer, cyanoacrylate or polyurethane. This fastening can also be ensured by a complementary layer deposited or affixed between the underframe and the bottom of the housing.

Advantageously, said spacer is made of a material having a thermal conductivity of at most 0.4 W·m-1·K-1, preferably a thermal conductivity of at most 0.2 W·m-1·K-1.

In certain alternative embodiments, the material is composed of plastic.

Advantageously, said spacer is made of a polymer material or of a polymer-based composite material.

According to one possibility offered by the invention, said spacer comprises a material from the silicate family, preferably being made of fiber-reinforced calcium silicate.

Advantageously, the inter-battery spacer has, at least at its longitudinal segments, an increased rigidity, that is to say a Young's modulus of at least 5 GPa (gigapascal) and an elastic limit of at least 60 GPa.

The present invention also relates to a thermal regulation system for a set of battery cells of a motor vehicle housing, said system comprising:
a set of battery cells comprising at least a first and a second battery cell, the first and second battery cells being in the form of a rectangular parallelepiped having two large lateral faces, two small lateral faces, a lower face and an upper face, the first and the second battery cells being aligned contiguous at one of their large lateral faces,
a housing the set of battery cells, said housing having a bottom.

The thermal regulation system is noteworthy in that it comprises at least one inter-battery spacer as described above, disposed in the housing, preferably on the bottom of the housing, the battery cells being separated by and resting on at least the inter-battery spacer.

Advantageously, the thermal regulation system further comprises at least one spray nozzle for a dielectric fluid, connected to a supply circuit for transporting said fluid, said nozzle being configured to spray said at least two battery cells, preferably on their upper and/or lateral faces, such that the dielectric fluid flows by gravity from said upper/lateral face toward the lower face of each battery cell.

According to one aspect of the invention, the base of the spacer has a smaller width than the width of the lower face of the battery cell.

Advantageously, the set of battery cells comprises n batteries, n being an integer greater than or equal to 3, and at least (n−1) inter-battery spacers, advantageously n inter-battery spacers.

### BRIEF DESCRIPTION OF THE DRAWINGS

Further advantages and features of the invention will become better apparent from reading the following description of a preferred embodiment, given with reference to the attached drawings, produced by way of nonlimiting indicative examples and in which:

FIG. 1 is a schematic view of a battery;

FIG. 2 is a view of an embodiment of an inter-battery spacer according to the invention;

FIG. 3 is a schematic view of the inter-battery spacer in FIG. 2 mounted around the battery shown in FIG. 1;

FIG. 4 is a schematic view illustrating two contiguous batteries each resting on an inter-battery spacer according to the invention;

FIG. 5 is a side view of a battery/inter-battery spacer assembly, according to FIG. 3 or 4;

FIG. 6 is a top view of the assembly visible in FIG. 4;

FIG. 7 is a schematic view of a housing intended to house batteries having a system for cooling these batteries by spraying; and

FIG. 8 is a schematic view of the housing shown in FIG. 7 in which batteries have been disposed, each battery resting on an inter-battery spacer.

### DETAILED DESCRIPTION OF THE INVENTION

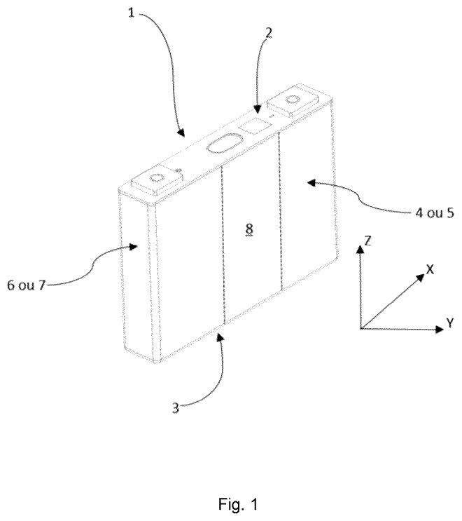

With reference to the orientations and directions of extension of the batteries 1 and of the inter-battery spacers 10, the longitudinal direction is represented by the longitudinal axis X, while the vertical axis Z and transverse axis Y represent the vertical and transverse directions, respectively. These axes together define a trihedron XYZ which is shown in FIGS. 1, 2 and 3. In this frame of reference, the terms “top” or “upper” are represented by the positive direction of the vertical axis Z, the terms “bottom” or “lower” being represented by the negative direction of this same vertical axis Z.

The thermal regulation system that forms the subject matter of the invention seeks to regulate the temperature of a battery pack 1, notably of a battery pack of an electric and/or hybrid motor vehicle. However, it may be fitted to other types of vehicles, or used to regulate the temperature of other electrical and/or electronic components such as power electronics elements, for example, and nonlimitingly, semiconductors, such as diodes or transistors. They could also be components of computer servers. According to a preferred embodiment, the thermal regulation consists in cooling the cells of the battery pack 1.

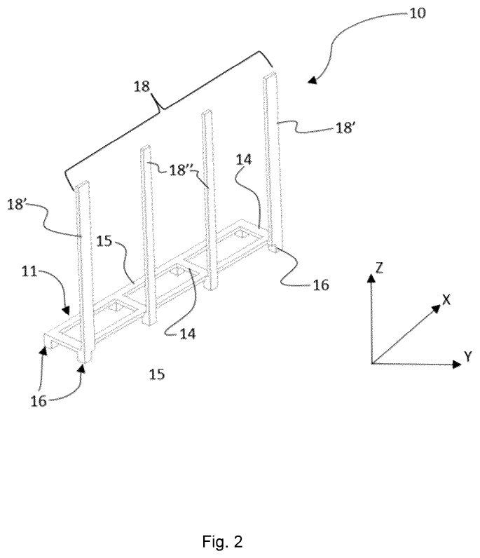

Thus, considering the battery 1 and the inter-battery spacer 10 shown respectively in FIGS. 1 and 2, their height is considered along the axis Z, their length along the axis X and their width along the axis Y.

The battery 1 can be shown diagrammatically in a rectangular parallelepipedal overall form. This parallelepipedal form has a length, a width and a height. Each battery 1 has an upper face 2 and a lower face 3 which are opposite one another and connected by two of the large lateral faces 4, 5 and two small lateral faces 6, 7.

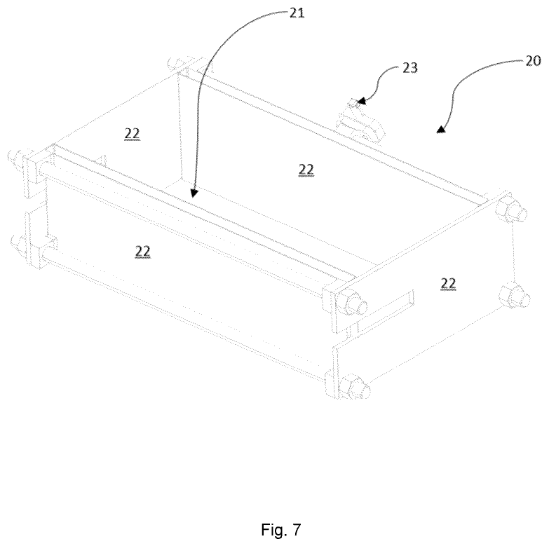

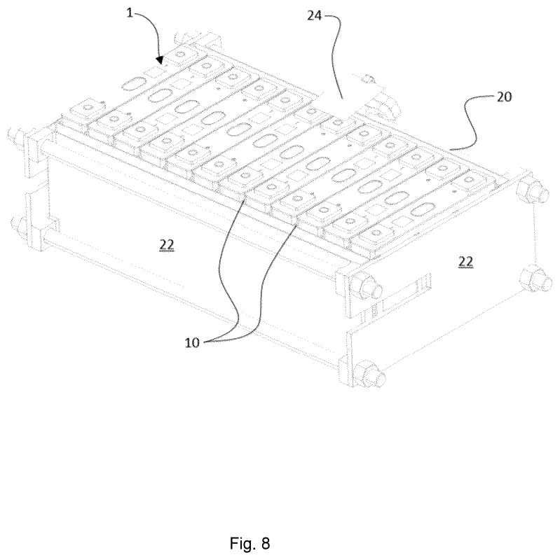

When these batteries 1 are placed in a housing 20 as shown in FIGS. 7 and 8, the upper face 2 of said batteries 1 is arranged facing the cover of the housing 20, while the lower face 3 of said batteries 1 is arranged facing the bottom 21 of the housing 20. The opposite upper face 2 and lower face 3 extend in the length and width directions of one or more batteries 1. The two large lateral faces 4, 5 extend in the direction of the height (Z) and the length (X) of the battery 1. The two small lateral faces 6, 7 extend in the direction of the width (Y) and the height (Z). Of course, any other forms for the batteries 1 may be envisioned.

The large lateral faces 4, 5 each have a central portion defined as representing 50% of the surface of said large lateral faces, at the central part of each of said faces.

As can be seen in FIG. 8, the batteries 1 are disposed in a row or in several rows within the internal volume of the housing 20. In instances where there are several rows of batteries 1, the latter 1 are advantageously disposed parallel to one another. Specifically, the housing 20 comprises lateral walls 22 connected by a bottom wall 21. The walls 22 of the housing 20 delimit an internal volume in which the batteries 1 are received.

The housing 20 can have dimensions and a form that differ from those illustrated in FIGS. 7 and 8 as long as this housing 20 fulfills its function of housing batteries 1, the latter 1 advantageously resting on a bottom 21 so as to be aligned with respect one another. Advantageously, the housing 20 housing the batteries 1 is leak-tight with respect to exterior fluids so as to not compromise the integrity of the batteries 1.

FIG. 2 shows an embodiment of an inter-battery spacer 10 according to the invention.

In this exemplary embodiment, the base 11 of the inter-battery spacer 10 is rectangular and perforated, comprising three cutouts 12 which are themselves rectangular. These cutouts 12 are advantageously produced between the longitudinal segments 18 such that the perforated base 11 has four sections 14 extending in the width connecting two large sections 15 extending in the length. Of course, the perforated base 11 may have different forms and dimensions as long as it fulfills its function of supporting a battery 1 by its lower face 3 and allows the dielectric fluid to come into contact with this lower face 3 by virtue of the cutouts 12, the latter 12 being able to have various forms and dimensions without diminishing the mechanical strength of this base 11.

However, it can be noted that the base 11 is perforated to an extent of at least 50%—the cutouts 12 provided in the base represent a surface area of at least 50% of said base 11—advantageously to an extent of at least 70%, or even to an extent of at least 80%.

The inter-battery spacer 10 in this case also comprises four longitudinal segments 18 extending in the height. These segments 18 all extend from the perforated base 11 along a single vertical side of this base 11. Two segments 18′ are situated at the two opposite ends of the perforated base 11, while two segments 18″ are situated in a portion referred to as central with reference to the central portions 8 of the large lateral faces of the batteries 1. In this case, these four segments 18 have the same height, but it can of course be envisioned that each segment 18 has a height that differs from that of the other segments 18 or that a first group of segments, for example the segments 18′, have a first height while a second group of segments, for example the segments 18″, have a second height that differs from the first height.

According to one possibility offered by the invention, the end longitudinal segments 18′, that is to say those intended to be situated in proximity to the small lateral faces 6, 7, comprise at least one transversely extending (along the axis Y) lateral stud, which is not shown in the attached figures. The function of such lateral studs is to wedge the battery 1 in the housing 20 by bearing against or contacting the lateral walls 22 of the housing 20. It can also be envisioned that the longitudinal segments 18″ situated in or at the central portion 8 are provided with one or more of such lateral studs.

Of course, the number and the dimensions of the longitudinal segments 18 can be different as long as they fulfill their main functions of constraining the battery 1, in particular at the central portion 8 of its large lateral faces 4, 5, during heating of the latter 1, and of spacing with a contiguous battery 1.

As indicated above, these main functions are supplemented by a secondary function concerning the facilitation of the flow of the dielectric fluid along in particular its large lateral faces 4, 5. To this end, these longitudinal segments 18 extend in the height—the flow of the dielectric fluid being effected essentially vertically from the upper face of the batteries by virtue of the gravitational force—and cover a small surface area of the large lateral face 4 or 5 against which they bear or are in contact. Thus, as has been seen above, the surface of a large lateral face 4, 5 is occupied by the longitudinal segments 18 to an extent of at most 10%, advantageously to an extent of at most 5%. It can also be noted that the longitudinal segments 18 are not necessarily in contact with the battery 1 and can have a minimum distance of the order of 0.5 mm or less with respect to the latter 1.

Lastly, the underframe 16 of the base in this case consists of vertical studs. These vertical studs 16 extend, on the one part, in line with the longitudinal segments 18 from one of the large sections 15 of the base 11, and, on the other part, in line with intersections between the other large section 15 of the base 11 and each of the transverse sections 14. Thus, in the embodiment illustrated in FIG. 2, eight vertical studs 16 form the underframe of the perforated base 11. Of course, the number and the dimensions of these studs 16 can be different from this embodiment as long as they fulfill their function of raising the base 11, and therefore the battery 1, with respect to the bottom 21 of the housing 20 containing them.

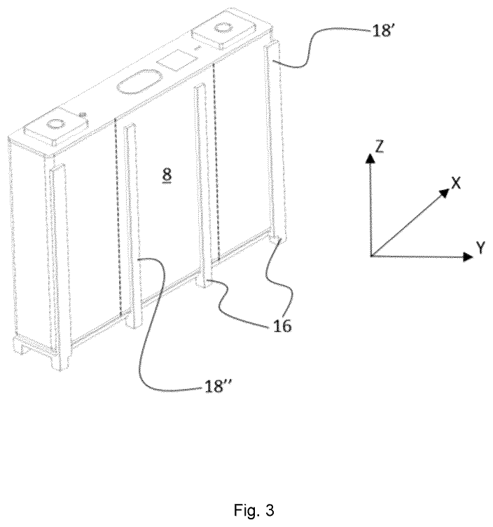

When a battery 1 is mounted on an inter-battery spacer 10, it can be seen in the embodiment in FIG. 3 that the longitudinal segments 18 do not extend in height as far as the upper surface 3 of the battery 1. Nevertheless, these longitudinal segments 18 can have at most a height identical to that of the battery 1.

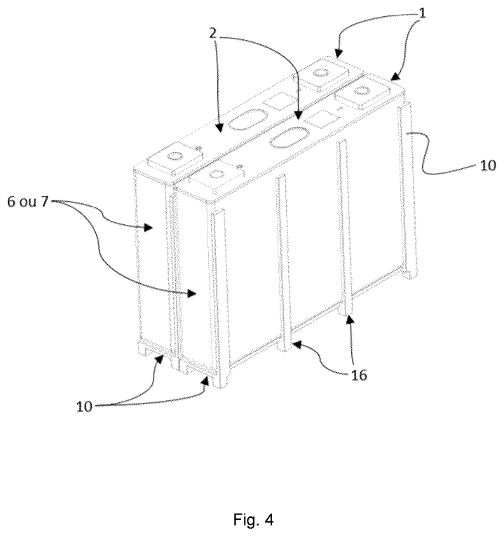

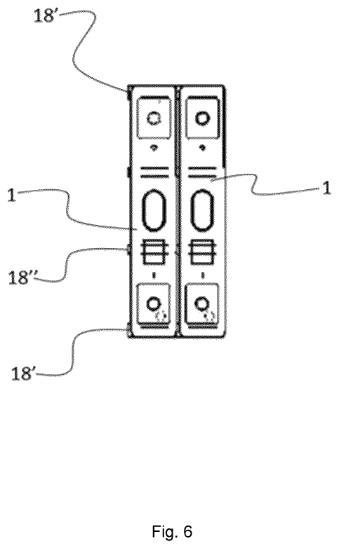

FIGS. 4, 5 and 6 illustrate two batteries 1 each having an inter-battery spacer 10. The batteries 1 are identical in terms of size and form but, again, it can be envisioned that the batteries 1 have a different size and/or form as long as they 1 have between them a facing face 4 or 5 and a lower face 3 intended to rest on the perforated base 11 of an inter-battery spacer 10. The distance between two contiguous batteries 1 is substantially equal to the width (along the axis Y) of a longitudinal segment 18 such that the latter 18 is advantageously in contact with, or at a very small distance (smaller than 0.5 mm) from, the two large lateral faces 4, 5 of each of the two contiguous batteries 1.

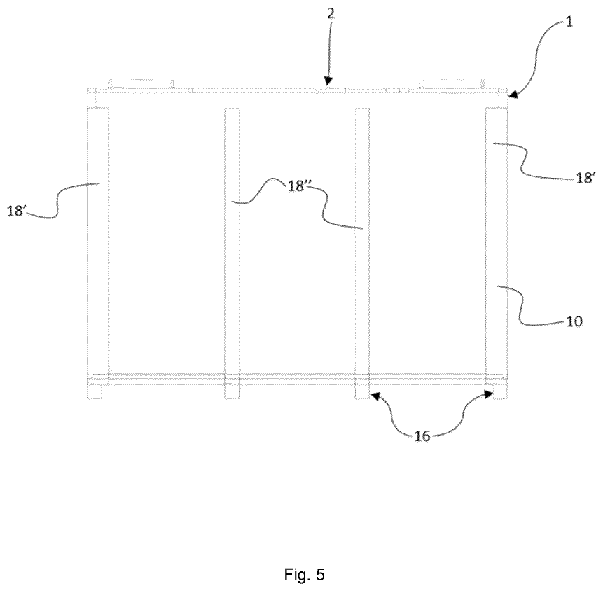

The side view, FIG. 5, shows that the longitudinal segments 18 can have a variable length (along the axis X), the two end segments 18′ having a length approximately 150% greater than that of the segments 18″ intended to cover or contact the central portion 8. The end segments 18′ extend in close proximity to the small lateral faces 6, 7 of a battery 1, while the longitudinal segments 18″ of the central portion 8 extend at said portion 8 so as to centrally represent 50% of the surface of a large lateral face 4, 5.

In this example, the inter-battery spacer 10 comprises two end segments 18′ and two segments referred to as central segments 18″ (situated in or at the central portion 8), but of course the number of longitudinal segments 18 can vary. Nevertheless, there will always be at least one longitudinal segment 18″ in or at the central portion 8 of a large lateral face 4, 5, while the end segments 18′ can potentially not exist for a spacer 10. Furthermore, according to an advantageous embodiment, the number of longitudinal segments 18″ situated in the central portion 8 is at least equal to the number of end longitudinal segments 18′, the latter 18′ being at least two in number.

In the context of the present invention, “dielectric fluid” is understood to mean a medium which does not contain electric charges able to move macroscopically. Such a medium is thus not a conductor of electric current and can be defined as an electrical insulator. Currently, mineral oils occupy close to 95% of this market considering the fact that it is used in this case as cooling fluid for batteries.

The dielectric fluid that is able to circulate in the cooling circuit for the batteries 1, which is not shown in the attached figures, is chosen according to its phase change temperatures. More particularly, the dielectric fluid should be characterized at least by a phase change temperature such that this dielectric fluid, sprayed in the direction of the batteries in the liquid state, is capable of being partially vaporized on contact with said batteries 1. Reference is thus made to diphase dielectric fluid, in that it has two different phases during its circulation in the thermal regulation system. By way of example, the dielectric fluid should have an evaporation temperature at atmospheric pressure that is higher than a temperature of around 32-34° C., and a condensation temperature that is lower than a temperature of around 29-31° C.

The dielectric fluid circuit is not visible in the attached figures but it conventionally comprises a member for circulating the dielectric fluid, such as a pump. The flow of the dielectric fluid in the circuit for said fluid may be controlled via this member and a storage tank for dielectric fluid may also be provided. Once it has been projected, notably in the liquid phase, the dielectric fluid can be drawn back in by another pump. The dielectric fluid drawn back in can potentially be conveyed to a heat exchanger for cooling before being reintroduced into the dielectric fluid circuit for the thermal regulation of the batteries 1.

The dielectric fluid circuit may comprise one or more lines for supplying the one or more spray nozzles 23. In the embodiment shown in FIG. 8, only one spray nozzle 23 is depicted, the latter 23 being connected to a deflector 24 for vaporizing and dispersing the dielectric fluid over a large number of batteries 1 adjacent to the spray nozzle 23.

As has been outlined above, the spray zone and the recovery zone for the dielectric fluid are advantageously provided on either side of the batteries 1 to be thermally regulated. The spray zone is situated in the upper or top part of the housing 20, while the recovery zone situated in the lower or bottom part of the housing 20.

Although the invention has been described in connection with several particular embodiments, it is obvious that it is in no way limited thereto and that it comprises all technical equivalents of the means described and any combinations thereof if these fall within the scope of the invention.

The arrangement of the various elements and/or means and/or steps of the invention, in the embodiments described hereinabove, must not be interpreted as demanding such an arrangement in all implementations. In any case, it will be appreciated that various modifications may be made to these elements and/or means and/or steps without departing from the spirit and scope of the invention. In particular:
there may be longitudinal segments 18 covering and/or in contact with the other faces of the batteries 1, that is to say the other large lateral face 4 or 5 and one of the two small lateral faces 6, 7;
the batteries 1 may be replaced by any types of components or modules to be thermally regulated with the aid of a dielectric fluid;
the dielectric fluid circuit may be different, both in terms of structure and in terms of function, as long as it sprays the batteries 1 essentially on the upper faces 2 of the latter 1, or on the small lateral faces 6, 7;
the housing 20 housing the batteries 1 may be different, both in terms of dimensions and form, as long as it fulfills its function of housing said batteries 1;
the dielectric fluid and the means used for its action for cooling the batteries 1 may be different.

The use of the verb “have”, “comprise” or “include” and its conjugated forms does not exclude the presence of elements or steps other than those set out in a claim.

In the claims, any reference sign between parentheses should not be interpreted as limiting the claim.

What is claimed is:

1. An inter-battery spacer intended to space apart two contiguous battery cells in a housing for battery cells of a vehicle,
the first and second battery cells each being in the form of a rectangular parallelepiped having two large lateral faces, two small lateral faces, a lower face and an upper face,
the first and the second battery cells being configured to be aligned and contiguous respectively at one of their large lateral faces,
wherein the inter-battery spacer consists of a one-piece element positioned in contact around the first battery cell, said inter-battery spacer comprising:
a base on which said lower face of the first battery cell is at least partially intended to rest, and
a plurality of longitudinal segments extending from said base in the direction of said upper face of said first battery cell, at least one of said longitudinal segments extending along the large lateral face contiguous with the second battery cell such that said segment is configured to come into contact with the contiguous second battery cell.

2. The inter-battery spacer as claimed in claim 1, wherein said base has an underframe intended to raise the battery cell with respect to a bottom of the housing.

3. The inter-battery spacer as claimed in claim 1, wherein the base is perforated.

4. The inter-battery spacer as claimed in claim 1, wherein the longitudinal segments include at least one longitudinal segment referred to as end longitudinal segment, configured to be situated in close proximity to one of the aforementioned small lateral faces.

5. The inter-battery spacer as claimed in claim 4, wherein the said end longitudinal segment(s) includes at least one transversely extending lateral stud.

6. A thermal regulation system for a set of battery cells of a motor vehicle housing, said system comprising:
a set of battery cells including at least a first and a second battery cells, the first and second battery cells being in the form of a rectangular parallelepiped having two large lateral faces, two small lateral faces, a lower face and an upper face, the first and the second battery cells being aligned contiguous at one of their large lateral faces,
a housing the set of battery cells, said housing having a bottom,
wherein said thermal regulation system further comprises at least one inter-battery spacer disposed in the housing,
the inter-battery spacer consisting of a one-piece element positioned in contact around the first battery cell, said inter-battery spacer comprising:
a base on which said lower face of the first battery cell is at least partially intended to rest, and
a plurality of longitudinal segments extending from said base in the direction of said upper face of said first battery cell, at least one of said longitudinal segments extending along the large lateral face contiguous with the second battery cell such that said segment is configured to come into contact with the contiguous second battery cell,
with the battery cells being separated by and resting on at least the inter-battery spacer.

7. The thermal regulation system as claimed in claim 6, wherein all the longitudinal segments of the inter-battery spacer extend along that large lateral face of the first battery cell which is contiguous with the second battery cell.

8. The thermal regulation system as claimed in claim 6, wherein at least two longitudinal segments, preferably at least half of the longitudinal segments, extend in a central portion of that large lateral face of the first battery cell which is contiguous with the second battery cell, said central portion representing at most 50% of said large face.

9. The thermal regulation system as claimed in claim 6, wherein the longitudinal segments occupy at most 10% of the surface of that large lateral face of the first battery cell which is contiguous with the second battery cell.

10. The thermal regulation system as claimed in claim 6, wherein at least one of said longitudinal segments extends in length over the entirety of the lateral face of the first battery cell.

11. The thermal regulation system as claimed in claim 6, further comprising at least one spray nozzle for a dielectric fluid, connected to a supply circuit for transporting said fluid, said nozzle being configured to spray said at least two battery cells, preferably on their upper and/or lateral faces, such that the dielectric fluid flows by gravity from said upper/lateral face toward the lower face of each battery cell.

12. The thermal regulation system as claimed in claim 6, wherein the base of the inter-battery spacer has a smaller width than the width of the lower face of the battery cell.

13. The thermal regulation system as claimed in claim 6, wherein the set of battery cells includes n batteries, n being an integer greater than 3, and at least (n−1) inter-battery spacers.
